(19) United States
(12) Patent Application Publication
(10) Pub. No.: US 2005/0092793 A1
(43) Pub. Date: May 5, 2005

(54) Viewing platform for portable electronic entertainment device

(76) Inventor: Bradley S. Berggren, Westport, CT (US)

Correspondence Address: EDWARDS & ANGELL, LLP, P.O. BOX 55874, BOSTON, MA, 02205, US

(21) Appl. No.: 10/701,291

(22) Filed: Nov. 4, 2003

(51) Int. Cl. B60R 7/00

(52) U.S. Cl. 224/275

(57) ABSTRACT

A viewing platform for a portable video player is disclosed which includes an elongated base defining a front end portion and a rear end portion, a stage provided at the rear end portion of the base for accommodating a portable video player, and at least one adjustable strap operatively associated with the front end portion of the base for securing the base to a supporting structure.

### BACKGROUND OF THE INVENTION

1. Field of the Invention

The subject invention relates generally to a viewing platform for a portable electronic entertainment device, and more particularly, to a platform which is adapted and configured to be mounted upon the center console located between the two front seats of an automobile to provide a stable viewing surface for a portable video player accessible to occupants in the rear seat of the vehicle.

2. Background of the Related Art

Systems for positioning a supporting surface or other object near a seated person are often installed in automobiles, aircraft and other vehicles. Typically, such systems include a moveable arm having one end permanently connected to a base structure and another end connected to a deployable object. In aircraft and other vehicles, the arm may be connected to the floor of the vehicle or to a portion of a passenger seat. The arm is usually adapted for movement between a stowed position and a deployed position to facilitate access to, and storage of, the deployable object. For example, commercial aircraft commonly provide stowable tray tables for each seated passenger.

Another example of a stowable system is a personal entertainment device, such as a DVD player. DVD players are original equipment in many automobiles today and typically deploy from a stowed position located within the roof of the passenger compartment, or they may be permanently mounted within a front seat headrest. The use of a portable DVD player in an automobile presents a problem however, as there is generally an absence of a rigid support surface to accommodate the video player and provide an adequate viewing position for the occupants of the rear seating area.

One solution to this problem is the advent of a suspension system consisting of a set of adjustable straps for suspending a portable DVD player between the two front seats of the automobile at an ideal viewing height and angle. Such a system is unstable over rough terrain and can be difficult to assemble. It would be beneficial therefore, to provide a system for supporting a portable DVD player within an automobile in a stable manner while providing a comfortable viewing position for passengers.

### SUMMARY OF THE INVENTION

The subject invention is directed to a novel viewing platform for an electronic entertainment device, such as a portable video player, and more particularly, to a platform which is adapted and configured to be secured to a supporting structure located between the two front seats of an automobile to provide a stable viewing surface for a portable video player accessible to occupants in the rear seat of the vehicle. The viewing platform is preferably constructed from an elongated base structure formed from a lightweight, rigid material and having a front end portion and a rear end portion. A stage is provided at the rear end portion of the base structure for accommodating a portable video player, and means are operatively associated with the front end portion of the base for securing the base structure to a supporting structure.

Preferably, a rectangular frame forms the stage, and the frame includes an aperture for accommodating a power cable associated with the video player. Means are positioned within the frame for frictionally securing the video player upon the stage. For example, a mat or pad may be situated within the frame to provide frictional resistance to movement. In addition, the mat or pad may be cushioned to absorb shocks.

Preferably, the means for securing the base to a supporting structure includes at least one adjustable strap for engaging a supporting structure. It is envisioned that the strap could have a buckle to permit lengthwise adjustments or a hook and loop type closure mechanism could be provided on the strap to provide lengthwise adjustments. This will accommodate differences in the size of the structure to which the platform is secured. Preferably, the front end portion of the base has at least one channel formed therein to accommodate the at least one adjustable strap. In one embodiment of the subject invention, the base structure includes a storage compartment adjacent the front end portion thereof, which may be used to store DVD's or the like.

These and other aspects of the subject invention will become more readily apparent to those having ordinary skill in the art from the following detailed description of the invention taken in conjunction with the drawings.

### BRIEF DESCRIPTION OF THE DRAWINGS

So that those having ordinary skill in the art to which the present invention pertains will more readily understand how to make and use the viewing platform of the present invention, embodiments thereof will be described in detail hereinbelow with reference to the drawings, wherein:

FIG. 1 is an illustration of the viewing platform of the subject invention installed on the center console between the two front seats of an automobile with a portable video player positioned thereon;

FIG. 2 is an exploded perspective view of the viewing platform of the subject invention; and

FIG. 3 is a perspective view of another embodiment of the viewing platform of the subject invention, which includes an integral storage compartment.

### DETAILED DESCRIPTION OF PREFERRED EMBODIMENTS

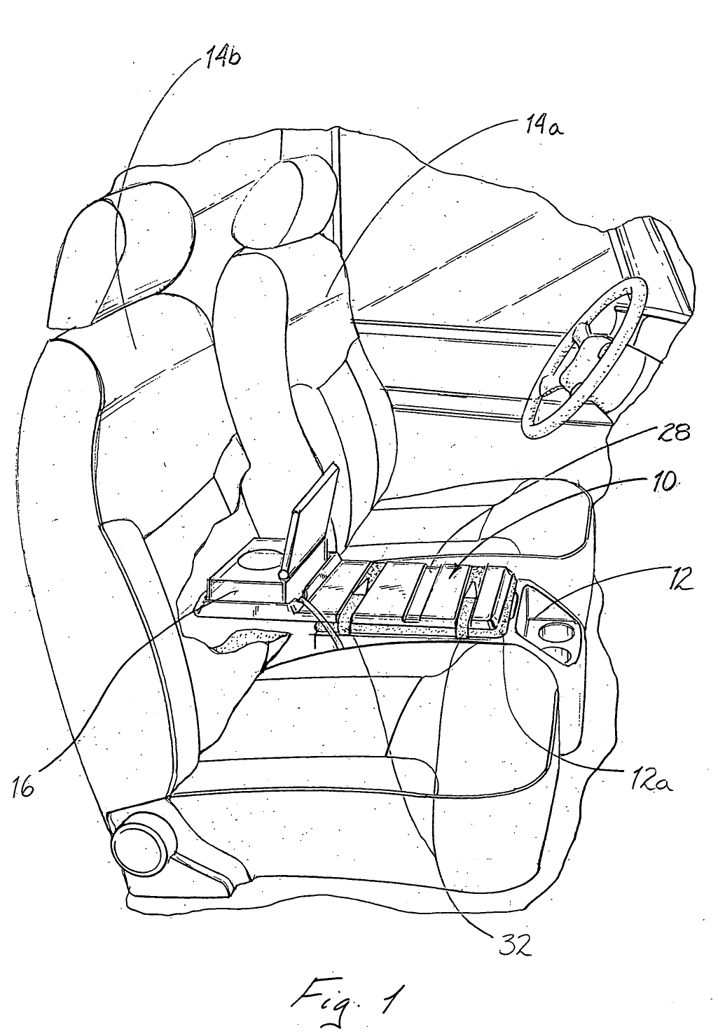

Referring now to the drawings, wherein like reference numerals identify similar structural features or aspects of the subject invention, there is illustrated in FIG. 1 a viewing platform for a portable video player constructed in accordance with a preferred embodiment of the subject invention and designated generally by reference numeral 10. Viewing platform 10 is particularly adapted and configured to cooperate with the center console or armrest 12 located between the two front bucket seats 14a, 14b of an automobile. The platform provides a stable support surface to accommodate a portable DVD player 16 or similar electronic device, in a readily accessible and easily viewed position for passengers occupying the rear seating area of the vehicle.

Viewing platform 10 is defined by an elongated base structure 20 constructed from a lightweight, rigid material. For example, the base structure 20 may be formed from a high strength plastic material that can be formed through injection molding or a similar forming process, and the plastic may be color matched with the interior trim and in particular the center console of the vehicle. Alternatively, the base structure 20 may be formed from a hardwood or laminated wood product and may be stained or painted to match the interior wood grains of the passenger compartment of the vehicle. Preferably, viewing platform 10 has a substantially uniform thickness over the majority of its length and width. However, it is envisioned that sections of the base structure, particularly in the undersurface side of the platform, may have void areas where there is an absence of material to reduce the overall weight of the platform, as well as manufacturing costs.

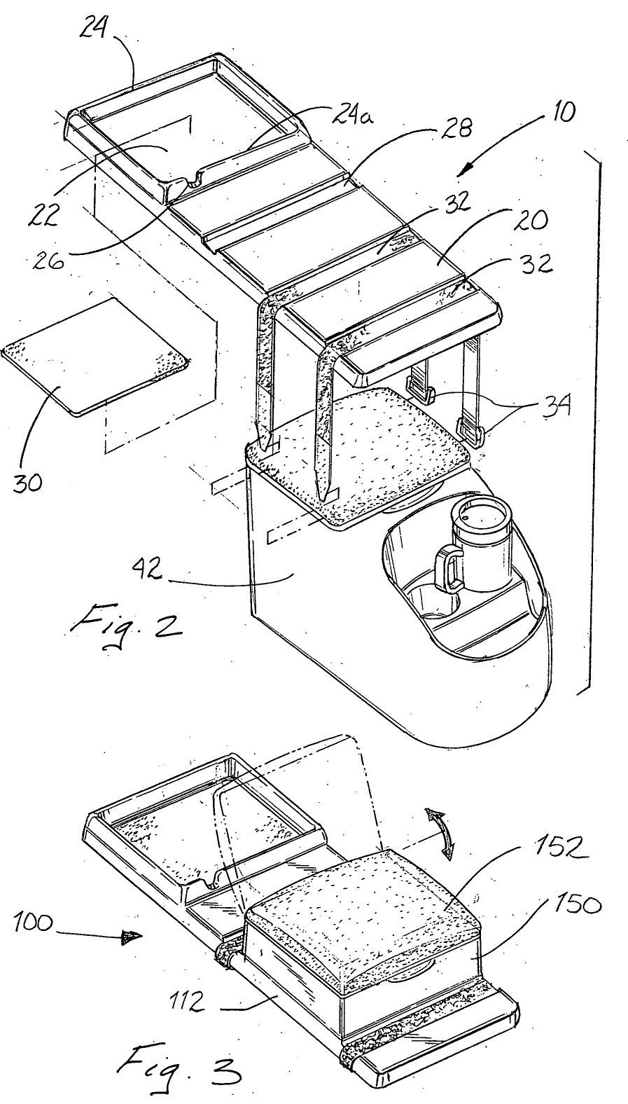

Referring to FIG. 2, the base structure 20 of viewing platform 10 includes a rear staging area 22 for accommodating a portable video player or a similar portable electronic entertainment device, such a portable video gaming machine. Staging area 22 is preferably rectangular in shape and is defined by an upstanding peripheral wall 24. In the case of a molded plastic structure, the peripheral wall 24 of the staging area 22 would preferably, but not necessarily, be integrally formed with the base structure 12. In the case of a wooden structure, the upstanding peripheral wall 24 of the staging area 22 would be attached to the upper surface of the base structure 20 by fasteners or by an adhesive.

The front section 24a of peripheral wall 24 includes an aperture or cutout 26 for accommodating a power cable associated with the portable video player, as illustrated for example in FIG. 1. In the case of a wooden structure, the front section of the peripheral wall may be shortened to create a passage or opening for a power cable in a similar manner.

A frictional resistance pad or mat 30 is disposed within the staging area 22 to inhibit unwanted movement of the video player relative to the base structure 20. The pad or mat 30 may be rubberized or formed from rubber or a similar material having a similar or greater coefficient of friction. The material should be selected so as not to cause abrasive damage to the video player after prolonged contact therewith. The pad 30 may be removably disposed within the staging area 22 or it may be secured within the staging area 22 by an adhesive or by similar means. Preferably, the pad 30 is cushioned or has a sufficient thickness to provide shock absorption for the DVD player 16 when the vehicle is driving over rough terrain or uneven road surfaces.

Base structure 20 further includes at least one, but preferably more than one, and more preferably at least two or three, transverse recesses or channels 28 formed in the front end portion of the base 20. Each recess or channel 28 is dimensioned and configured to accommodate an adjustable securement strap or belt 32. The straps or belts 32 are designed to secure the base structure 20 to a supporting structure, namely, the center console 12 of an automobile (see FIG. 1). More particularly, the straps 32 are designed to extend below and around either a hinged cover 12a of the center console 12 or a cantilevered armrest (not shown). The straps 32 are preferably dimensioned and the recesses 28 are preferably located to accommodate variations in the dimensions and types of supporting structures found in most automobiles (compare the two strap locations for the center console 12 shown in FIG. 1 to the two strap locations for the center console 42 shown in FIG. 2). The straps 32 may be formed from an elastic material and may be provided with a buckle 34 or a similar fastening device, as shown for example in FIG. 2. The straps 32 can also have a hook and loop fastening arrangement associated therewith, which is also illustrated in FIG. 2.

As best seen in FIG. 1, when viewing platform 10 is secured to the center console 12 by straps 32, the rear staging area 22 projects into the rear seating area of the vehicle, in a cantilevered manner, so as to provide easy access to the DVD player by the occupants of the rear seating area.

Referring now to FIG. 3, there is illustrated another viewing platform constructed in accordance with a preferred embodiment of the subject invention and designated generally by reference numeral 100. Viewing platform 100 is substantially identical in both form and function to viewing platform 10, except that viewing platform 100 includes an associated storage compartment 150 with a hinged cover 152, which may be cushioned for driver comfort. In the case of a plastic viewing platform, the storage compartment 150 may be integrally or monolithically formed with the base structure 112 of the platform 100, as illustrated in FIG. 3. In the case of a wooden viewing platform, the storage compartment may be attached to the base structure by fasteners or by an adhesive. It is envisioned that the compartment 150 would be dimensioned and configured to enclose DVD's or similar sized objects.

Although the subject invention has been described with respect to preferred embodiments, those skilled in the art will readily appreciate that changes and modifications may be made thereto without departing from the spirit and scope of the subject invention as defined by the appended claims

1. A viewing platform for a portable electronic entertainment device comprising:
a) an elongated base defining a front end portion and a rear end portion;
b) a stage provided at the rear end portion of the base for accommodating a portable electronic entertainment device; and
c) means operatively associated with the front end portion of the base for securing the base to a supporting structure.

2. A viewing platform for a portable electronic entertainment device as recited in claim 1, wherein the stage is formed by a rectangular frame.

3. A viewing platform for a portable electronic entertainment device as recited in claim 2, wherein the frame includes an aperture for accommodating a power cable associated with the video player.

4. A viewing platform for a portable electronic entertainment device as recited in claim 2, wherein means are positioned within the frame for frictionally securing the video player upon the stage.

5. A viewing platform for a portable electronic entertainment device as recited in claim 1, wherein the means for securing the base to a supporting structure includes at least one adjustable strap for engaging a supporting structure.

6. A viewing platform for a portable electronic entertainment device as recited in claim 3, wherein the front end portion of the base has at least one channel formed therein to accommodate the at least one adjustable strap.

7. A viewing platform for a portable electronic entertainment device as recited in claim 1, wherein the base is constructed from a plastic material.

8. A viewing platform for a portable electronic entertainment device as recited in claim 1, wherein the base is constructed from wood.

9. A viewing platform for a portable electronic entertainment device as recited in claim 1, wherein the base includes a storage compartment adjacent the front end portion thereof.

10. A viewing platform for a portable video player for use within an automobile having front bucket seats and a rear seating area, the viewing platform comprising:
a) an elongated base defining a front end portion and a rear end portion;
b) a stage provided at the rear end portion of the base for accommodating a portable video player; and
c) at east one adjustable strap operatively associated with the front end portion of the base for securing the base to a supporting structure located between the front bucket seats of the automobile, such that the rear end portion of the base projects into the rear seating area of the automobile in a cantilevered manner, presenting the stage to passengers in the rear seating area.

11. A viewing platform for a portable video player as recited in claim 10, wherein the stage is formed by a rectangular frame.

12. A viewing platform for a portable video player as recited in claim 10, wherein the frame includes an aperture for accommodating a power cable associated with the video player.

13. A viewing platform for a portable video player as recited in claim 10, wherein means are positioned within the frame for frictionally securing the video player upon the stage.

14. A viewing platform for a portable video player as recited in claim 10, wherein the front end portion of the base has at least one channel formed therein to accommodate the at least one adjustable strap.

15. A viewing platform for a portable video player as recited in claim 14, wherein the at least one channel is formed in an upper surface of the base.

16. A viewing platform for a portable video player as recited in claim 10, wherein the base is constructed from a plastic material.

17. A viewing platform for a portable video player as recited in claim 10, wherein the base is constructed from wood.

18. A viewing platform for a portable video player as recited in claim 10, wherein the base includes a storage compartment adjacent the front end portion thereof.

19. A viewing platform for a portable video player comprising:
a) an elongated base having a longitudinal axis and defining a front end portion and a rear end portion;
b) a stage provided at the rear end portion of the base for accommodating a portable video player; and
c) at least one channel formed in an upper surface of the base, within the front end portion thereof, and extending perpendicular to the longitudinal axis of thereof for accommodating an adjustable strap adapted to secure the base to a supporting structure.

20. A viewing platform as recited in claim 19, further comprising at least one adjustable strap for securing the base to a supporting structure.
